(19) United States
(12) Patent Application Publication
(10) Pub. No.: US 2014/0009833 A1
(43) Pub. Date: Jan. 9, 2014

(54) Lens with an Out-Coupling Element

(71) Applicants: Mikko Juhola, Muurla (FI); Pasi Saarikko, Espoo (FI); Marko Parikka, Salo (FI)

(72) Inventors: Mikko Juhola, Muurla (FI); Pasi Saarikko, Espoo (FI); Marko Parikka, Salo (FI)

(73) Assignee: Nokia Corporation, Espoo (FI)

(21) Appl. No.: 13/984,051

(22) PCT Filed: Feb. 14, 2011
(86) PCT No.: PCT/IB2011/050606

§ 371 Date: Sep. 17, 2013

(51) Int. Cl. G02B 27/00; G02B 5/18; G02B 3/00

(52) U.S. Cl. CPC G02B 27/0018; G02B 3/00; G02B 5/1814
USPC 359/571; 359/811; 359/738; 359/569

(57) ABSTRACT

A lens including: a central refracting portion and a peripheral portion configured to support the lens in a lens mount wherein the peripheral portion has a surface including at least one out-coupling element configured to couple light out of the lens.

### TECHNOLOGICAL FIELD

Embodiments of the present invention relate to a lens. In particular, they relate to a lens for use in a camera.

### BACKGROUND

Ghost images may be recorded at a camera because light reflects from portions of the camera onto the recording area. This light is in addition to the light received directly from imaged objects.

Where the source of the reflected light is relatively intense, such as the Sun, the ghosting effect can be significant.

### BRIEF SUMMARY

According to various, but not necessarily all, embodiments of the invention there is provided a lens comprising: a central refracting portion and a peripheral portion configured to support the lens in a lens mount wherein the peripheral portion has a surface comprising at least one out-coupling element configured to couple light out of the lens.

Coupling light out of the lens at the peripheral portion prevents it being totally internally reflected towards the central refracting portion.

The out-coupling element may be a diffraction arrangement. One example of a diffraction arrangement is a diffraction grating.

Some embodiments of the invention, by using diffraction, reduce image ghosting.

The use of diffraction enables the control of the number and direction of propagating transmitted and/or reflected diffraction orders. Light can thus be re-directed, using propagating diffraction orders, towards areas where incident light does not produce ghosting. The diffracted light may, for example, be absorbed or redirected to prevent total internal reflection or directed away from a camera sensor.

### BRIEF DESCRIPTION

For a better understanding of various examples of embodiments of the present invention reference will now be made by way of example only to the accompanying drawings in which:

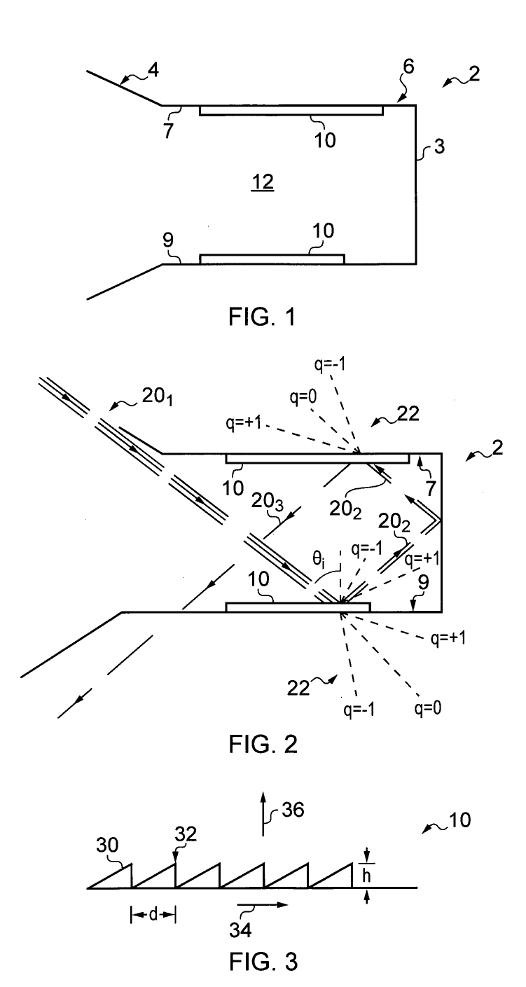

FIG. 1 illustrates an example of a lens;

FIG. 2 illustrates an example of the lens illustrated in FIG. 1 when it is in use;

FIG. 3 illustrates an example of a cross-section through an example of one type of suitable out-coupling element;

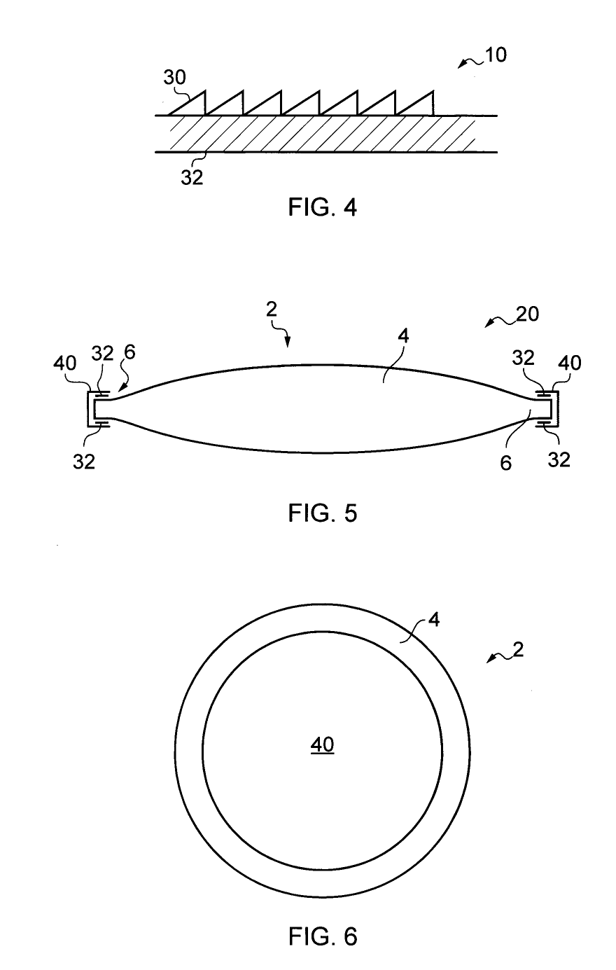

FIG. 4 illustrates an example of a cross-section through an example of how to absorb light transmitted by an out-coupling element;

FIG. 5 illustrates an example of a cross-sectional view through a lens arrangement in use;

FIG. 6 illustrates an example of a top plan view of the lens illustrated in FIG. 5; and

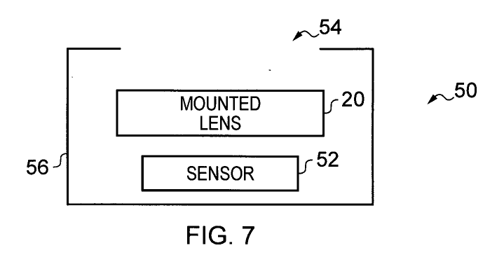

FIG. 7 illustrates an example of a camera comprising the lens.

### DETAILED DESCRIPTION

At least some of the Figures illustrates a lens 2 comprising: a central refracting portion 4 and a peripheral portion 6 configured to support the lens 2 in a lens mount 40 wherein the peripheral portion 6 has a surface 7, 9 comprising at least one out-coupling element 10 configured to couple light out of the lens 2 preventing it being totally internally reflected towards the central refracting portion 4.

FIG. 1 illustrates a lens 2. The Figure is a cross-sectional view through the lens 2.

The lens 2 comprises a central refracting portion 4 that reshapes an incident wave front of light in a controlled way using refraction. The central refracting portion 4 provides the optical power of the lens 2 and has a carefully controlled shape.

The lens 2 also comprises a peripheral portion 6 that is configured to support the lens 2 in a lens mount 40 (see FIG. 5, for an example). The peripheral portion 6 is not designed to refract impinging light and does not contribute to the optical power of the lens 2. The peripheral portion 6 is designed to enable the lens 2 to be supported by the lens mount 40.

The peripheral portion 6 may be shaped as a flange. The peripheral portion 6 has an outer surface 7 and an inner surface 9 connected via an end surface 3. The outer surface 7 and the inner surface 9 are typically opposing and may be substantially parallel to each other and they may be orthogonal to the end surface 3.

The lens 2 is typically unitary in that it is formed from as a single entity and is not a composite of multiple entities. However, the lens 2 could also be a composite, e.g. achromatic doublet. The lens 2 is typically homogeneous in that it is formed from homogeneous refractive transparent material 12.

The peripheral portion 6 of the lens 2 has, in this example, an outer surface 7 comprising an integrated outer out-coupling element 10. The outer out-coupling element 10 is configured to couple out of the peripheral portion 6 of the lens 2 light, which is directed outwards from within the lens 2 and impinges onto the outer surface 7 of the peripheral portion 6 of the lens. This may prevent at least some of the impinging light being totally internally reflected towards the central refracting portion 4 where it may introduce noise into an image imaged by the central refracting portion 4 of the lens 2.

The peripheral portion 6 of the lens 2 has, in this example, an inner surface 9 comprising an inner out-coupling element 10. The inner out-coupling element 10 is configured to couple light that is directed inwards and impinges onto the inner surface 9 of the peripheral portion 6 of the lens 2 out of the peripheral portion 6 of the lens 2. This may prevent at least some of the light being totally internally reflected ultimately towards the central refracting portion 4 where it may introduce noise into an image imaged by the central refracting portion 4 of the lens 2.

The outer out-coupling member 10 and the inner out-coupling member 10 are positioned in opposition on respectively the outer surface 7 and the inner surface 9 of the peripheral portion 6 of the lens 2. The outer out-coupling element 10 and the inner out-coupling element 10 may be directly opposite each other for at least some of the extent of the outer out-coupling element 10 and the inner out-coupling element 10.

An out-coupling element 10 may be, for example, a diffraction arrangement such as a diffraction grating, or it may be a prism, or an array of prisms, a diffusing surface, or a medium in contact with the surface of the peripheral portion 6 that causes the frustration of total internal reflection.

A diffraction arrangement comprises a repetitive (periodic) pattern of elements. The repetitive elements have the same size and/or orientation. The repetitive pattern of elements creates periodic alterations in the phase, amplitude or both phase and amplitude of an incident light wave. A diffractive arrangement may, for example, be a two-dimensional or three-dimensional array of elements (e.g. dots) or it may be a one dimensional periodic array of elements (e.g. a diffraction grating).

A transmission phase grating 10, an example of which is illustrated in FIGS. 3 and 4, may, for example, be formed by engineering transverse parallel grooves at the surface of the peripheral portion 6. A via may be, for example, formed by microlithography or when injection molding the lens 2 during manufacture.

A transmission phase grating 10 may be one-dimensional (as described above) or two dimensional. A two-dimensional grating comprises two crossed one dimensional gratings.

The periodicity of the diffractive arrangement may be selected to control which diffraction orders are propagating and which diffraction orders are non-propagating for light within a visible spectrum of light as described below.

FIG. 2 illustrates the lens 2 illustrated in FIG. 1 when it is in use.

In the absence of the inner out-coupling element 10 and the outer out-coupling element 10, a light ray 20₁ incident upon the outer surface 9 of the peripheral portion 6 of the lens 2 with an angle of incidence θᵢ may be totally internally reflected. This will typically be the case when the angle of incidence is greater than the critical angle θ_{c}, which may be of the order 40 degrees. The reflected light ray 20₂, would be incident upon an end surface 3 of the peripheral portion 6 of the lens 2 with an angle of incidence 90−θᵢ. In this example it is totally internally reflected towards the outer surface 7 of the peripheral portion 6 of the lens 2. This will typically be the case when the 90−θᵢ is greater than the critical angle θ_{c}, which may be of the order 40 degrees. The reflected light ray 20₁ is then incident upon the outer surface 7 of the peripheral portion 6 with an angle of θᵢ and may be totally internally reflected in an inwards direction (towards a camera sensor 52 as illustrated in FIG. 7). For total internal reflection to occur off the outer surface 9, the end surface 3 and the outer surface 7, in this configuration, then 90−θ_{c}>θᵢ>θ_{c}.

With the presence of one or more diffractive arrangements 10, the amount of light totally internally reflected in an inwards direction (towards a camera sensor 52 as illustrated in FIG. 7) is significantly reduced. In FIG. 2, the intensity of a light ray 20ₙ is indicated by the number of parallel lines. The greater the number of parallel lines the greater the intensity.

In this example, the inner out-coupling element 10 is a transmission diffraction grating. The outer out-coupling element 10 is also a transmission diffraction grating. The diffraction gratings 10 will enable diffraction of light to transmitted (out-coupled) diffraction orders, as well as diffraction of some part of the light to reflected diffraction orders.

Referring to FIG. 3, which illustrates an example of a diffraction grating, a diffraction grating 10 has elements 32 that are separated by a grating period d. The periodicity defines a first direction 34 in a plane of the diffraction grating 10 (the grating vector). A second direction 36 normal to the plane and the first direction 34 defines an orientation of the diffraction grating 10.

The grating 10 is formed at an interface between a first medium (the material 12 of the peripheral portion 6 of the lens 2) and a second medium (the air space on the exterior of the peripheral portion 6 of the lens 2). The first medium 12 from which the light ray is input has a refractive index n₁. The second medium into which the light ray is transmitted (out-coupled) has a refractive index n₂.

The first medium 12 may, for example, be formed from polymethylmathacrylate (PMMA), polyvinylidene chloride, polysifone resin or glass. The second medium may be air.

A zenith angle θ is the angle formed between a light ray and the second direction 36. An azimuthal angle φ is the angle formed between the first direction 34 and a projection of the light ray onto the plane of the diffraction grating.

An input light ray has a relationship to the diffraction grating defined by an input zenith angle θᵢ and an input azimuthal angle φᵢ.

An output light ray has a relationship to the diffraction grating defined by an output zenith angle θ_{q} and an output azimuthal angle φ_{q}.

A grating equation (1) defines the relationship between the input light ray r(θᵢ, φᵢ) and the output light ray, at the diffraction order q, r(θ_{q}, φ_{q}.),

$${k}^{2} {n}_{2}^{2} {sin}^{2} ( {θ}_{q} ) = {k}^{2} {n}_{1}^{2} {sin}^{2} ( {θ}_{i} ) {cos}^{2} ( {φ}_{i} ) + {( {k}^{2} {n}_{1}^{2} sin ( {θ}_{i} ) sin ( {φ}_{i} ) + 2 π q / d )}^{2} \qquad ( 1 )$$

where k is the magnitude of the wave vector

$$k = 2 π / {λ}_{0}$$

where λ₀ is the wavelength of the light in a vacuum.

When the azimuthal angle is zero, the equation (1) can be reduced to

$$\begin{matrix}k {n}_{2} sin ( {θ}_{q} ) = k {n}_{1} sin ( {θ}_{i} ) + 2 π q / d \\ or & ( 2 ) \\ sin ( {θ}_{q} ) = \frac{{n}_{1}}{{n}_{2}} sin ( {θ}_{i} ) + \frac{q {λ}_{0}}{{n}_{2} d} & ( 3 )\end{matrix}$$

It may be desirable to control how light is coupled out of the first medium 12 at the peripheral portion 6 of the lens 2 into the second medium (air).

Considering transmitted diffraction orders T_{q} for light incident on the grating at an angle greater than the critical angle for total internal reflection, as a first example, let only the diffraction orders T₀ and T₋₁ be propagating.

Consequently equation (3) only has real solutions for q=0 and q=−1. For this mode of operation (sin(θ₋₁)<1), the grating period is given by

$$d > \frac{{λ}_{0}}{{n}_{1} sin ( {θ}_{i} ) + {n}_{2}}$$

Furthermore, Equation (3) only has non-propagating solutions for q≦−2, i.e. sin(θ₋₂)∉ [symbol] , when the grating period is given by

$$d \leq \frac{2 {λ}_{0}}{{n}_{1} sin ( {θ}_{i} ) + {n}_{2}} .$$

Therefore α<d≦2α, where α=λ₀/n₁ sin(θᵢ)+n₂.

Another constraint that may be satisfied is that for 90−θ_{c}>θᵢ>θ_{c} equation (3) has a non-propagating solution for q=1. For this mode of operation (θ₁≧π/2), the grating period is given by

$$d \leq \frac{{λ}_{0}}{{n}_{2} - {n}_{1} sin ( {θ}_{i} )} ,$$

90−_{c}>θᵢ>θ_{c}

The grating period d can be controlled to determine which diffraction orders are propagating and which diffraction orders are non-propagating for a particular angle of incidence θᵢ that could result in total internal reflection e.g. 90−θ_{c}>θᵢ>θ_{c}.

In this way it is possible to control using the grating period d which transmitted diffraction orders T_{q} are propagating and couple light out of the peripheral portion 6 of the lens 2.

It is also possible to control the angles θ_{q}, φ_{c}, of the transmitted diffraction order T_{q} by controlling the grating period d and its orientation.

Considering reflected diffraction orders, R_{q}. It is desirable to have solutions for θ_{q} such that reflected diffraction orders are not totally internally reflected i.e. the condition 90−θ_{c}>θ_{q}>θ_{c} is not satisfied. If θ_{q}>90−θ_{c} at the outer surface 9 then total internal reflection will not occur at the end surface 3. If θ_{q}<θ_{c} at the outer surface 9 then total internal reflection will occur at the end surface 3 but not subsequently at the outer surface 7. In this way the grating period can be selected so that reflected non-zero diffraction orders propagate at angles that do not support the round trip off outer surface 9, end surface 3 and outer surface 7.

In is also possible to control using the grating period d which reflected diffraction orders R_{q} are propagating and in which direction to retain light in the peripheral portion 6 of the lens 2 using the diffraction grating 10.

The periodicity of the diffraction arrangement (e.g. the grating period d of a diffraction grating) 10 may be determined to selectively propagate particular transmitted diffraction orders for light within a visible spectrum of light.

The periodicity of the diffraction arrangement (e.g. the grating period d of a diffraction grating) 10 may be determined to propagate, at selected angles, reflection diffraction orders for light within a visible spectrum of light.

The intensity distribution of light in diffraction orders existing for a given grating period, d, depends on the shape of the grating profile. This allows for optimization of the intensity distribution of light for a given task by suitable profiling of the grating grooves.

In the simplified example of FIG. 2, a light ray 20₁ incident upon an inner diffraction grating 10 at the inner surface 7 of the peripheral portion 6 with an angle of incidence θᵢ will be transmitted 22 through the diffractive grating 10 to propagating transmitted diffraction orders. Some light may be returned into the peripheral portion 6 to the propagating reflected diffraction orders. Some of this returned light 20₂ may be reflected by an end portion 3 of the peripheral portion 6 of the lens 2 towards the outer diffraction grating 10 at the outer surface 7 of the peripheral portion 6 of the lens 2.

The light rays 20₂ incident upon the outer diffraction grating 10 will be transmitted 22, at least partially, through the diffraction grating 10 to propagating transmitted diffraction orders. Some light may be returned into the peripheral portion 6 by diffraction to the propagating reflected diffraction orders (which may be limited to n=0) in an inwards direction (towards the camera sensor 52 in FIG. 7). However, the intensity of the light that travels inwards (towards the camera sensor 52 in FIG. 7) is significantly reduced by the presence of the inner and/or outer diffraction gratings 10.

FIG. 3 illustrates a cross-section through an example of one type of suitable out-coupling element 10. The out-coupling element 10 is a transmission diffraction grating with a grating period d. The grating comprises a series of identical, equally spaced right-angled triangular projections (blazes) with a blaze height h. The properties of the diffraction grating may be controlled, for example, by varying the grating period and/or the blaze height h or blaze angle. Controlling the blazes 30 may reduce image ghosting.

FIG. 4 illustrates a light absorbing element 32 positioned to absorb light coupled out of the lens 2 by the out-coupling element 10. It illustrates, in a cross-section an example of one type of suitable out-coupling element 10. This out-coupling element 10 is similar to that illustrated in FIG. 3. In this example, a black spacer element 32 is positioned on the transmission side of the diffraction grating 10. The black spacer 32 is configured to absorb light of the propagating transmitted diffraction orders T_{q} that pass through the diffraction grating 10.

FIG. 5 illustrates a cross-sectional view through an apparatus 20 in use. The apparatus 20 is a lens arrangement comprising a lens mount 40 holding the lens 2.

In this example, the lens mount 40 engages with the peripheral portion 6 of the lens 2, supporting the lens 2.

The out-coupling elements 10 integrated into the lens 2 at the peripheral portion 6 of the lens 2 are configured to couple light out of the lens 2 in the region of the lens mount 40.

The lens mount 40 comprises an outer member and an inner member. The outer member is a stiff cantilevered projection from an upper part of a stiff supporting portion of the lens mount 40. The inner member 6 is a stiff cantilevered projection from a lower part of the stiff supporting portion of the lens mount 40. The outer member and/or the inner member may, however, resiliently flex when a lens 2 is inserted into the lens mount 40. In the illustrated example the inner member and the outer member of the lens mount 40 are parallel and straight but this is not necessarily always the case.

The separation of the upper part and the lower part of the supporting portion 3 creates a space between the inner member and the outer member. This space is configured to receive the peripheral portion 6 of the lens 2 as illustrated in FIG. 5. The term configured in this context may mean that the size of the space is of a fixed size, however, the fixed sized may be varied or may be permanent.

FIG. 6 illustrates a top plan view of the lens 2 illustrated in FIG. 5. The peripheral portion 6 of the lens 2 is an annular flange. The space between the outer surface 7 and the inner surface 9 of the flange 6 forms an annulus

The outer out-coupling element 10 may be annular and integrated as part of the outer surface 9 of the annular flange 6. The annular outer out-coupling element 10 and the annular peripheral portion 6 may have the same radius of curvature.

The inner out-coupling element 10 may be annular and integrated as part of the inner surface 9 of the annular peripheral portion 6. The annular inner out-coupling element 10 and the annular peripheral portion 6 may have the same radius of curvature.

The outer out-coupling element 10 and the inner out-coupling element 10 are annular and are mutually configured to retain light between the inner and outer surfaces 7, 9 of the lens flange 6. Total internal reflection is constrained within the annular space between the inner surface 9 and the outer surface 7 of the peripheral flange portion 6 of the lens 2. Light is directed to complete circuits around the annular flange 6.

The out-coupling elements 10 may be diffraction gratings. The elements 32 of the diffraction grating 10 may be arranged radially i.e. the first direction 34 may be radial. Alternatively, the elements 32 of the diffraction grating 10 may be arranged circumferentially i.e. the first direction 34 may be circumferential. The lens arrangement 20 further comprises light absorbing elements positioned to absorb light diffracted by the out-coupling elements 10 into an interior of the lens mount 40.

FIG. 7 illustrates a camera 50 comprising the a lens arrangement 20, a sensor 52 and an aperture 54 in a housing 56. In this example, the lens arrangement 20 comprises a lens mount 4 and a lens 2. The camera may additionally comprise a mechanism for adjusting the aperture 54.

As used here ‘module’ refers to a unit or apparatus that excludes certain parts/components that would be added by an end manufacturer or a user. The lens 2 may be a module. The lens arrangement 20 may be a module. The camera 50 may also be a module.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1. A lens comprising:
a central refracting portion and
a peripheral portion configured to support the lens in a lens mount
wherein the peripheral portion has a surface comprising at least one out-coupling element configured to couple light out of the lens.

2. An apparatus as claimed in claim 1, further comprising at least one light absorbing element positioned to absorb light coupled out of the lens by the out-coupling element.

3. A lens as claimed in claim 1, wherein the out-coupling element is a diffraction arrangement.

4. A lens as claimed in claim 3, wherein the diffraction arrangement is a periodic arrangement of elements and wherein the periodicity is selected to enable visible light to be coupled out of the lens material.

5. A lens as claimed in claim 3, wherein the diffraction arrangement is a periodic arrangement of elements and wherein the periodicity is selected to enable visible light to be propagated from the lens material at a first transmitted diffraction order but not a second transmitted diffraction order.

6. A lens as claimed in claim 3, wherein the diffraction arrangement is a periodic arrangement of elements and wherein the periodicity is selected to prevent visible light at reflected diffraction orders other than the zeroth reflected diffraction order being subsequently totally internally reflected.

7. An apparatus as claimed in claim 1, wherein the out-coupling element is annular.

8. An apparatus as claimed in claim 7, wherein the out-coupling element is an integrated portion of an annular flange of the lens.

9. A lens as claimed in claim 1, wherein the out-coupling element is a diffraction grating.

10. A lens as claimed in claim 9, wherein the diffraction grating is a transmission diffraction grating.

11. A lens as claimed in claim 1, wherein the out-coupling element is positioned at an inner surface of a lens flange or wherein the out-coupling element is positioned at an outer surface of a lens flange.

12. A lens as claimed in claim 1, comprising an inner out-coupling element positioned at an inner surface of a lens flange and an outer out-coupling element positioned at an outer surface of the lens flange.

13. A lens as claimed in claim 12, wherein the inner out-coupling element and the outer out-coupling element are in an opposing configuration.

14. A lens as claimed in claim 12, wherein the inner out-coupling element and the outer out-coupling element are diffraction gratings.

15. A lens as claimed in claim 14, wherein the inner out-coupling element and/or the outer out-coupling element are/is a diffraction grating comprising blazes.

16. A lens as claimed in claim 15, wherein the blazes are controlled to increase the intensity of propagating transmitted diffraction orders compared to propagating reflected diffraction orders.

17. A lens as claimed in claim 12, wherein the inner out-coupling element is annular and/or the outer out-coupling element is annular.

18. A lens as claimed in claim 17 wherein the inner out-coupling element and the outer out-coupling element are annular and are mutually configured to retain light between the inner and outer surfaces of the lens flange.

19. A lens as claimed in claim 12, further comprising light absorbing elements positioned to absorb light diffracted by the inner out-coupling element and the outer out-coupling element.

20. A lens arrangement comprising:
a lens;
a lens holder holding the lens at a periphery; and
at least one out-coupling element located at the periphery of the lens and configured to couple light out of the lens.
